(19) United States
(12) Patent Application Publication
(10) Pub. No.: US 2007/0262266 A1
(43) Pub. Date: Nov. 15, 2007

(54) X-Ray Detector Comprising Scintillators That Are Attached To Both Sides Of A Light Sensor

(75) Inventors: Martin Hoheisel, Erlangen (DE); Markus Schild, Herzogenaurach (DE); Martin Spahn, Chicago, IL (US)

Correspondence Address: SCHIFF HARDIN, LLP;PATENT DEPARTMENT, 6600 SEARS TOWER, CHICAGO, IL, 60606-6473, US

(73) Assignee: SIEMENS AKTIENGESELLSCHAFT, Munchen (DE)

(21) Appl. No.: 11/628,190

(22) PCT Filed: May 31, 2005
(86) PCT No.: PCT/EP05/52466

§ 371 Date: Jul. 10, 2007

(30) Foreign Application Priority Data
Jun. 2, 2004 (DE) 10 2004 026 842.8

(51) Int. Cl. G01N 23/223

(52) U.S. Cl. 250/483.1

(57) ABSTRACT

An x-ray detector has a light sensitive detector that is substantially transparent to x-rays, and has opposite sides that are permeated by incoming x-rays. At each of said opposite sides, a scintillator is arranged on the sensor that converts the incoming x-rays into light at each of said opposite sides.

### BACKGROUND OF THE INVENTION

1. Field of the Invention

The invention concerns an x-ray detector with a sensor for detection of light generated from an x-ray radiation, and with a scintillator arranged on the sensor in the incidence direction of the x-ray radiation for conversion of the x-ray radiation into light; such an x-ray detector is, for example, known from DE OS 102 24 227 A1.

2. Description of the Prior Art

An x-ray detector of the above type is known from DE 102 24 227 A1.

In x-ray diagnostics the x-ray radiation is typically converted by scintillators into light, advantageously into visible light or light lying near the visible spectral range. A sensor registers the resulting light quantity and converts it into an image. Scintillators are used, among other things, for planar detectors, x-ray image intensifiers and x-ray film foil systems. The quality of a scintillator is primarily determined by the level of the light yield and by the spatial resolution. The light yield essentially depends on the thickness of the scintillator. The spatial resolution is determined (as shown in FIG. 1 using a scintillator formed as a powdered layer) by the light area A1 generated by a light cone after the passage of the light through the scintillator, the light cone arising from a light point generated by an appertaining x-ray.

The greater the thickness D1 of the scintillator in a region provided for the application, the higher the light yield, but the lower the spatial resolution, due to the light area A1 becoming wider with the thickness of the scintillator. In contrast to this, the light yield worsens at lower thicknesses D1, but the spatial resolution increases due to the now smaller light area A1.

To reduce the light cone and therewith the light area A1 as well as to improve the spatial resolution, the use of scintillators formed from segments (as shown in FIG. 2) is known (for example from DE OS 198 59 995 A1 and EP 0 534 683 A2) such that the maximum light area A1 on the exit surface between the oppositely-situated inner sides of the segments can be limited via light reflections on the inner sides of the segments. For example, needle-shaped, vapor-depositable layers such as cesium iodide doped with thallium are used as segmented scintillators. Another possibility is to use scintillators composed of many discrete individual segments.

### SUMMARY OF THE INVENTION

An object of the present invention is to provide an x-ray detector with increased light yield and/or improved spatial resolution.

The above object is achieved in accordance with the present invention by an x-ray detector for detection of light generated by incoming x-ray radiation, having a sensor that is substantially x-ray transparent and that is light sensitive, the sensor having opposite sides which are successively permeated by the incoming x-rays, with a scintillator disposed on each of said opposite sides of the sensor, the respective scintillators converting the incoming x-rays into light on both sides of the sensor.

Due to the doubled scintillator layer on both sides of an x-ray-transparent sensor and on both sides of a light-sensitive sensor, the inventive x-ray detector offers the advantage of an increased light yield and/or improved spatial resolution and therewith an improved imaging in comparison to scintillators applied to one side of the sensor.

Compared to an x-ray detector with scintillator material applied only on one side of the sensor and a defined layer thickness D1, a sensor with scintillator material of only half the layer thickness D2 respectively applied on both sides is inventively made, a distinctly improved spatial resolution can be achieved given the same light yield. Given scintillators applied on both sides of the entire thickness S1 of the sensor, a higher light yield can be achieved given the same spatial resolution compared to a sensor with a one-sided scintillator.

Scintillators are respectively applied as layers on the sensor in an advantageous manner. Scintillators respectively applied on the sensor as powdered layers are provided in an appropriate manner for a cost savings. Using these powdered scintillators a comparable light yield and spatial resolution as for scintillators of the same total layer thickness formed on one side from segments can be achieved with the two-sided layer, but with distinctly cheaper manufacturing.

Materials (for example ceramics) with novel improved properties (such as, for example, low luminescence) for the conversion of x-ray radiation into light can be used for an inventive powdered layer manufacturable with significantly lower costs in comparison to a corresponding segmented layer since said materials offer a sufficiently high spatial resolution and light yield via the two-sided application.

A sensor formed by an organic photodiode is appropriately provided in an embodiment.

### DESCRIPTION OF THE DRAWINGS

FIG. 1 is a side view of a conventional x-ray detector having a sensor with a powdered scintillator layer on one side of the sensor.

FIG. 2 is a side view of a conventional x-ray detector having a sensor with a segmented scintillator layer on one side of the sensor.

FIG. 3 is a side view of a conventional x-ray detector having a sensor with a needle-shaped scintillator layer on one side of the sensor.

FIG. 4 is a side view of an x-ray detector constructed in accordance with the present invention, having a sensor with a powdered scintillator layer on both sides thereof.

FIG. 5 shows the x-ray detector of FIG. 4, in an embodiment wherein the respective scintillator layers are of decreased thickness.

FIG. 6 is a side view of an x-ray detector constructed in accordance with the present invention having a sensor with a needle-shaped scintillator layer on each side thereof.

FIG. 7 is a side view of an x-ray detector constructed in accordance with the present invention, with multiple scintillator-sensor modules arranged in series.

### DESCRIPTION OF THE PREFERRED EMBODIMENTS

FIG. 1 shows a known x-ray detector 1 with a scintillator 3 of the thickness D1 fashioned on one side as a powdered layer for conversion of x-ray radiation 4 into light and with a sensor 2 for detection of the light. The light arises at interaction points 6 of the x-ray radiation 4 with the scintillator 3 and propagates on the path through the scintillator in the form of light cones 5; 5.1. The light in the form of light cones 5; 5.1 strikes one side of the sensor. The maximum light cone 5 is incident over the area A1 and thereby determines the spatial resolution.

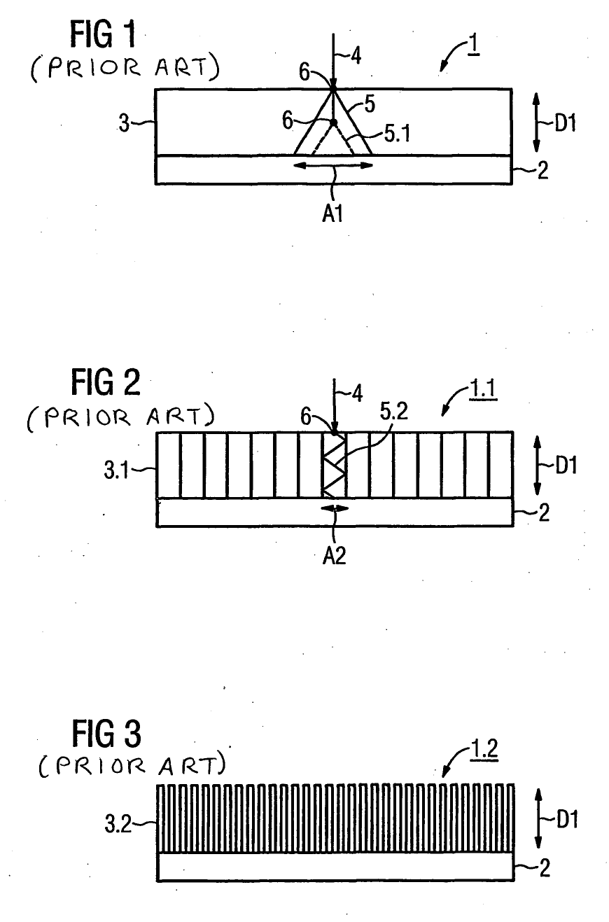

FIG. 2 shows a likewise known x-ray detector 1.1 that, relative to the known x-ray detector 1 with powdered layer according to FIG. 1, is improved having a segmented layer, for example with discrete individual segments of the thickness D1. This yields a better spatial resolution since the light 5.2, after conversion from the x-ray radiation 4, is localized reflection on the inner sides of the segments such that the area of the light cone A2 does not exceed the area of an individual segment and thus takes up a significantly smaller area in spite of the same scintillator thickness D1.

FIG. 3 shows a further x-ray detector 1.2 from the prior art with a sensor 2 in which, in contrast to the powdered layer and to the layer composed of discrete individual segments, the scintillator 3.2 is formed from a needle-shaped, vapor-deposited layer of the thickness D1. The layer can be a needle-shaped grown crystal such as, for example, Csl(TI).

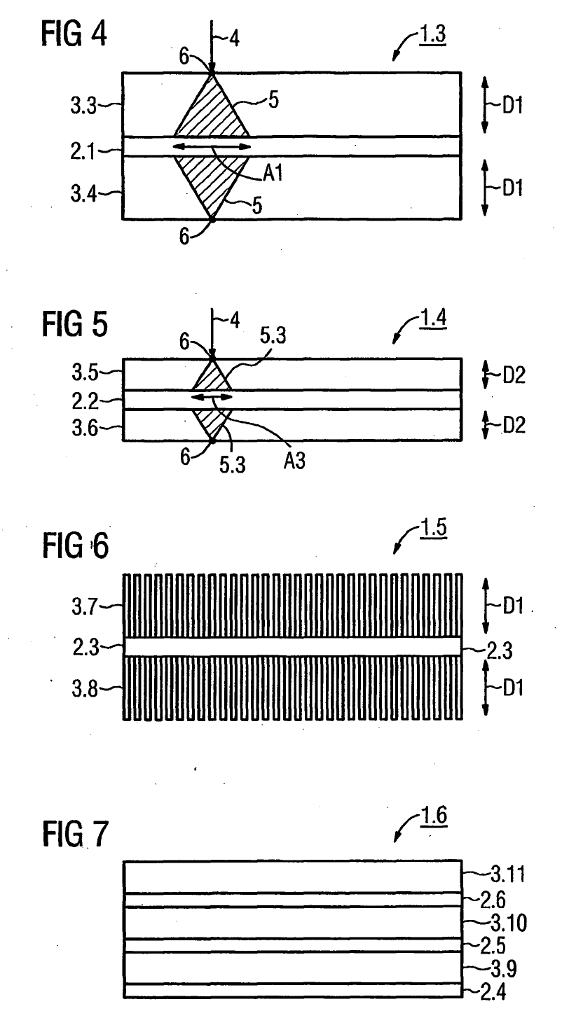

FIG. 4 shows an inventive x-ray detector 1.3 with scintillators 3.3 and 3.4 (respectively of the thickness D1 assumed for a one-sided scintillator in FIG. 1) applied on both sides of an x-ray-transparent sensor 2.1 in the incidence direction of the x-ray radiation. Scintillators 3.3 and 3.4 are respectively provided in an advantageous manner as powdered layers applied on the sensor 2.1. The x-ray radiation 4 is converted by the scintillators 3.3 and 3.4 into light, whereby only the maximum light cone 5 is shown. In comparison to an x-ray detector 1 known from the prior art with a one-sided scintillator 3 of the thickness D1 (FIG. 1), due to the total scintillator thickness D1+D1 the inventive x-ray detector 1.3 achieves a correspondingly higher light yield given equally good spatial resolution. Different layer thicknesses can also be provided for the scintillators 3.3 and 3.4.

FIG. 5 shows an inventive x-ray detector 1.4 (designed in fundamentally the same manner as in FIG. 4) with a sensor 2.2 and powdered scintillators 3.5 and 3.6 applied on both sides on the sensor with thickness D2 reduced by half relative to FIG. 4. Given unchanged incident light, a significant improvement of the light yield now results since the area A3 covered by the light cone 5.3 is significantly smaller. The scintillators 3.5 and 3.6 can be of different thickness.

FIG. 6 shows a further inventive x-ray detector 1.5 with an x-ray-transparent sensor 2.3 sensitive to light on both sides, given which a scintillator 3.7 and 3.8 formed in an advantageous manner from needles oriented in the incidence direction of the x-ray radiation is respectively provided on both sides instead of a powdered layer.

FIG. 7 shows a further inventive x-ray detector 1.6 with three scintillator-sensor modules 3.9; 2.4; 3.10; 2.5; 311; 2.6. The sensor 2.4; 2.5 is formed as at least one module (in the shown case two modules 3.10; 2.5; 3.11; 2.6), largely x-ray-transparent and respectively light sensitive as well as provided with one scintillator 3.9; 3.10; 3.11 per side on both sides in the incidence direction of the x-ray radiation. The scintillator 3.9 of a first module 3.9; 2.4 is associated not only with its sensor 2.4 but also with the sensor 2.5 of the subsequent module 3.10; 2.5. The various scintillator-sensor modules 3.9; 2.4; 3.10; 2.5; 311; 2.6 can be of different thicknesses.

The scintillators are formed as a respective vapor-deposited layers on the sensor in a manner appropriate for a low-complexity production. The x-ray-transparent sensor that is light-sensitive on both sides advantageously possesses a thickness in the μm range. It is formed in an advantageous manner by an organic photodiode. Sensors made from other materials can also be provided.

In an further embodiment of the invention the respective scintillators on both sides are formed from segments oriented in the incidence direction of the x-ray radiation. The scintillators are formed from discrete individual segments.

Scintillators can be used that are made from materials different from one another on the respective sides and/or with thicknesses differing from one another on the respective sides.

In summary, to improve the spatial resolution and increase the light yield, in an x-ray detector with a sensor for detection of light generated from an x-ray radiation, the sensor is largely x-ray-transparent and is respectively light sensitive and is provided with a scintillator on both sides in the incidence direction of the x-ray radiation for conversion of the x-ray radiation into light.

Although modifications and changes may be suggested by those skilled in the art, it is the invention of the inventors to embody within the patent warranted heron all changes and modifications as reasonably and properly come within the scope of their contribution to the art.

We claim as our invention:

1-10. (canceled)

11. An x-ray detector comprising:
a light sensitive sensor that is substantially transparent to x-rays, said sensor having opposite sides permeated by incoming x-rays; and
first and second scintillators respectively disposed on said opposite sides of said sensor and converting said incoming x-rays at each of said opposite sides into light.

12. An x-ray detector as claimed in claim 11 wherein each of said first and second scintillators comprises a layer applied on the sensor.

13. An x-ray detector as claimed in claim 11 wherein each of said scintillators comprises a powdered layer of scintillator material on said sensor.

14. An x-ray detector as claimed in claim 11 wherein each of said scintillators is a vapor-deposited layer on said sensor.

15. An x-ray detector as claimed in claim 11 wherein said x-rays are incoming along an incidence direction, and wherein each of said scintillators comprises segments oriented along said incidence direction.

16. An x-ray detector as claimed in claim 11 wherein said x-rays are incoming in an incidence direction, and wherein each of said scintillators is comprised of crystalline scintillator material having needle-shaped crystals oriented in said incidence direction.

17. An x-ray detector as claimed in claim 16 wherein each of said scintillators is comprised of a plurality of discrete individual segments.

18. An x-ray detector as claimed in claim 11 said sensor is an organic photodiode.

19. An x-ray detector comprising:
a plurality of scintillator-sensor modules disposed in series in a sandwich arrangement;
each of said scintillator-sensor modules comprising a light sensitive sensor that is substantially transparent to x-rays and having opposite sides respectively permeated by incoming x-rays, and respective scintillators disposed on said opposite sides that convert said incoming x-rays into light, with each sensor having two of said sensors on said opposite sides that, at each of said opposite sides, convert said incoming x-rays into light; and
said scintillator-sensor modules being disposed in said sandwich arrangement with said scintillators and said sensors alternating with each other starting and ending with a scintillator in said sandwich arrangement.
